(19) United States
(12) Patent Application Publication
(10) Pub. No.: US 2008/0128534 A1
(43) Pub. Date: Jun. 5, 2008

(54) SPRAY PUMP SYSTEM AND COUPLING APPARATUS

(76) Inventor: David J. McLeod, Auburn, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/866,196

(22) Filed: Oct. 2, 2007

Related U.S. Application Data
(60) Provisional application No. 60/868,025, filed on Nov. 30, 2006.

(51) Int. Cl. B05B 9/043

(52) U.S. Cl. 239/379; 239/602; 417/234; 464/161

(57) ABSTRACT

A connecting rod for coupling to a mating socket or to a coupler that includes a shaft having a longitudinal axis, a first end, and a second end, at least one of the first and second ends of the shaft having a substantially convex end face that is preferably arcuate or hemispherical in shape; and a spline formed on at least one of the first and second ends of the shaft, the spline having at least two projections that extend from the shaft to be substantially parallel to the longitudinal axis of the shaft, the projections contoured to accommodate universal movement of the shaft relative to the socket. The spline projections may be contoured to taper into the convex or hemispherical end face of the shaft.

### BACKGROUND OF THE INVENTION

1. Field of the Invention

The present disclosure pertains to equipment for transmitting a drive force from a prime mover to a driven member and, more particularly to a coupling apparatus for sprayers to couple a motor to a pump rotor on a spray machine for applying liquid.

2. Description of the Related Art

Mechanical coupling of a driver with a driven member can be accomplished in a number of ways, depending on the requirements of the particular application. In situations where there is a straight line between the driver and the driven member, a straight shaft can be used. For example, a propeller shaft is used to transfer the rotary force from an engine to a rotating propeller on aircraft and watercraft.

Where there is relative movement between the driver and the driven member, accommodation must be made. In rear-drive automobiles having a front-mounted engine, a long, rigid tube, known variously as a torque tube or drive shaft, couples a transmission bolted to the engine and the frame to a differential on a rear axle assembly. Because the rear axle assembly is attached to suspension that allows the automobile frame to move relative to the rear axle assembly, generally in a vertical direction, the frame and hence the drive shaft will change its position relative to the rear axle assembly. A universal joint is used at one or both ends of the drive shaft to accommodate this movement of the rear axle assembly.

While such universal joints are suitable for their purpose, they are impractical for applications in which space requirements constrain the size of the drive train components. Cost and complexity as well as load requirements are additional factors that make such universal joints unsuitable for these applications.

One example of such an application is spray equipment used to apply texture and acoustic materials to surfaces. Applicant's previously issued patent, U.S. Pat. No. 5,967,426, illustrates and describes a knock-down portable liquid drywall material spray system apparatus. FIGS. 1-5 and 11 from that patent are reproduced and described herein in conjunction with FIGS. 1-6.

More particularly, FIGS. 1-6 show a liquid drywall spray system 20, hereinafter referred to as the “spray system 20”, provided as a conveyance mechanism for delivering, under pressure, liquid drywall texture material (not shown) for application as an outer coating on the walls of homes, offices, and the like. The liquid material is conveyed through a hose 21 (shown in FIG. 6) to a location remote from the spray system 20. In addition, the spray system 20 can be employed to convey and deliver other types of viscous liquid.

Broadly stated, the spray system 20 comprises a frame 22 that provides support, either directly or indirectly, for all the primary components of the spray system 20. The general arrangement of the spray system 20 components is best illustrated in FIGS. 1 and 2. The spray system 20 includes an electrically activated DC motor 24 supported by a mounting bracket 25 that is attached to the frame 22. The motor 24 transmits power through a motor drive shaft 26 that rotates about a motor drive shaft axis 28.

Connected to the drive shaft 26 is a gear reducer 30. As illustrated, the gear reducer 30 is of the type referred to as a “right angle gear reducer,” such as one manufactured by “Faulk”. This type of gear reducer redirects, i.e., changes the drive train path by 90 degrees, which greatly enhances the compact feature of the spray system 20.

The gear reducer 30 includes a driven end 32 and a drive end 34. The driven end 32 is configured to securably engage the motor 24 so that the motor 24 is fixed or mounted to the gear reducer 30. Further, the driven end 32 is adapted to receive the motor drive shaft 26 and engage the same so that the motor 24 can transmit rotational power through the internal gear mechanism (not illustrated) of the gear reducer 30 to a gear reducer drive shaft 36. The gear reducer drive shaft 36 extends outward from the drive end 34. Accordingly, the gear reducer drive shaft 36 rotates responsive to the electrical activation of the motor 24.

Specifically, the motor drive shaft 26 rotates and transmits power through the gear reducer 30 that in turn steps down the motor RPM by a factor of approximately 5 to 1. Thus for every 5 revolutions of the motor drive shaft 26, the gear reducer drive shaft 36 turns 1 revolution. Accordingly, a motor that turns at a maximum of 1750 RPM will cause the gear reducer drive shaft 36 to rotate at 350RPM.

The motor 24 and gear reducer 30 are provided to drive a pump 38 of the progressive cavity type, which propels the liquid drywall material. The pump 38 has a pump housing 40 that is coupled directly to the drive end 34 of the gear reducer 30. As will be more fully discussed below, this “direct connection” design between the gear reducer 30 and the pump 38 simplifies the arrangement, connection and number of pump drive components. Moreover, this design eliminates the need for an exposed coupling connection between the gear reducer and the pump 38.

The pump housing 40 is shaped to define a containment chamber 42. The containment chamber 42 contains the liquid drywall material therein as it passes into and through the pump 38. For that purpose, the pump housing 40 includes an inlet port 44 that is in communication with the containment chamber 42. The inlet port 44 is disposed to receive and direct liquid drywall material into the containment chamber 42.

With the drive end 34 of the gear reducer 30 located at one end of the pump housing 40, the opposite end thereof is adapted to threadably receive a stator 46. Specifically, the stator 46 is threadably attached to the pump housing 40 such that it is in communication with the containment chamber 42. A rotor 48 is rotatably received within the stator 46 for rotation about a pump rotation axis 50. The rotor 48 rotates in response to rotation of the gear reducer drive shaft 36. It should be noted that the pump rotation axis 50 is disposed transverse to the motor drive shaft axis 28 and is aligned with the gear reducer drive shaft 36.

Considering now in more detail the components of the spray system 20, the pump 38 is designed to cantilever from the gear reducer 30. Thus the gear reducer 30 supports the entire weight of the pump 38 and all components that are attached thereto. As best illustrated in FIGS. 2, 3, and 4, it can be seen that the pump housing 40 has the shape of an inverted “TEE” and is hollow to define the containment chamber 42. The preferred method of manufacturing the pump housing 40 is to cast it from stainless steel for strength and ease of maintenance. The pump housing 40 includes a housing flange 52 that is bolted with four bolts 55 to gear reducer flange 54. To seal this connection, a flange gasket 56 is provided between the housing flange 52 and the gear reducer flange 54 and likewise a flange gasket 57 is provided between the gear reducer 30 and the gear reducer flange 54. The gear reducer flange 54 is attached to the gear reducer 30 by a plurality of bolts 59. The gear reducer drive shaft 36 is centrally disposed within the gear reducer flange 54 and extends into the pump housing 40.

As shown more clearly in FIG. 3, at the opposite end of the pump housing 40, along the pump rotation axis 50 is a threaded bore 58. The threaded bore 58 is sized to threadably receive a standard “off the shelf” stator 46 of the type that is employed in typical drywall spray equipment. In this way, a standard compatible rotor 48 can be aligned within the stator 46 along the pump rotation axis 50.

In order to connect the rotor 48 to the gear reducer drive shaft 36, a plurality of components are linked together along the pump rotation axis 50 within the pump housing 40. Connected to the gear reducer drive shaft 36 is a square drive coupler 62. The square drive coupler 62 is constructed from three primary components, i.e., a shaft receiver 65, a rod receiver 67, and a barrier plate 69. The shaft receiver 65 is configured to receive the round gear reducer drive shaft 36. Accordingly, a centrally disposed axial bore 63 is provided. The bore 63 is of a diameter to permit a close fit over the gear reducer drive shaft 36. To prevent relative rotational movement between the square drive coupler 62 and the gear reducer drive shaft 36, a key 64 is disposed therebetween. Opposite the shaft receiver 65 is a rod receiver 67 configured to receive a connecting rod 68. For this purpose, the rod receiver 67 includes a drive socket 66 for receiving a connecting rod 68. In this way, the square drive coupler 62 can be connected to the rotor 48 by a connecting rod 68. One end of the connecting rod 68 fits into the drive socket 64; the other end of the connecting rod 68 fits into a rotor socket 70 defined by the end portion of the rotor 48 that lies within the containment chamber 42.

It should be noted that the ends of the connecting rod 68 are generally square in shape, with slightly rounded edges, so that the same can be received into similarly shaped square sockets of the rotor 48 and the square drive coupler 62, i.e., the drive socket 66 and the rotor socket 70. In addition, as best seen in FIG. 5, the opposing square ends of the connecting rod 68 are not aligned. Rather, they are offset relative to one another by 45 degrees.

Referring again to the components of the square drive coupler 62, the barrier plate 69 is disposed between the shaft receiver 65 and the rod receiver 67. Because the shaft receiver 65 and the rod receiver 67 are in contact, a slight recess is machined into each piece so that the same can be press fit over the barrier plate 69. After the pieces are so fitted, the shaft receiver 65 and the rod receiver 67 are welded together around their abutting circumference.

Because the liquid drywall material can travel into any cavity that is not sealed, an additional mechanical seal 72 is provided around the gear reducer drive shaft 36 as illustrated in FIGS. 4 and 5. The mechanical seal 72 is a standard shaft-type seal manufactured by Pac-Seal, Inc. The mechanical seal 72 is combined with the square drive coupler 62, thereby reducing the need for special parts to hold the mechanical seal 72 in place along the gear reducer drive shaft 36. As a result, the square drive coupler 62 performs as part of the gear reducer drive shaft 36 as well as a retainer/holder for the mechanical seal 72.

The mechanical seal 72 is formed of a seal seat 73 disposed around the gear reducer drive shaft 36 and abutting the gear reducer flange 54. The seal seat 73 is urged against the gear reducer flange 54 by a spring 74 that is disposed between a spring retainer 75 and a drive band assembly 76. The spring retainer 75 fits over a reduced diameter portion 78 of the square drive coupler 62 and is urged against the shoulder 79 formed by the reduced diameter portion 78. The drive band assembly 76 is likewise urged against the seal seat 73. The drive band assembly 76 includes a centrally disposed rubberized bore that is sized to fit tightly around the gear reducer drive shaft 36 thus creating a seal therebetween. Although the thrust forces generated by the pump tend to keep the square drive coupler 62 engaged with the gear reducer drive shaft 36, a set screw 80 is employed through threaded bore 77 of the square drive coupler 62 against key 64. All components of the mechanical seal 72 rotate with the gear reducer drive shaft 36 except for the seal seat 73, which is stationary.

Turning again to FIGS. 2 and 3, the inlet port 44 defines an inlet bore 81 through which liquid drywall material is directed. The inlet port 44 is in communication with the containment chamber 42 so that liquid drywall material can be funneled therein. For this purpose, an industry standard female lever camloc 82 is provided and is welded to the inlet port 44 as illustrated in FIGS. 1 and 2.

The female lever camloc 82 permits the quick connection and disconnection of various sources of liquid drywall material. A hopper 84 is provided in the shape of a funnel. The hopper 84 is constructed in one piece from aluminum. Located at the narrow bottom portion of the hopper 84 is an outlet bore 85 around which a compatible industry standard male camloc 86 is mounted. With this arrangement, the hopper 84 can be directly supported from the pump housing 40 through the connection of the male and female camloc connection. Specifically, the male camloc 86 is inserted into the female lever camloc 82, and the lever 87 is then positioned to lock the two together. In order to complete the seal, a gasket 88 is disposed between the female lever camloc 82 and the male camloc 86.

Because a female lever camloc 82 is employed on the pump housing 40, a supply hose 90 having a male camloc 86 on the end thereof can be substituted for the hopper 84 as a supply means for liquid drywall material. This feature allows the user to connect any source of liquid drywall material to the pump 38 through the use of a supply hose 90. Thus, this configuration does not limit the sources of liquid drywall material to hoppers.

The liquid drywall material is fed through the hopper 84 by gravity into the pump housing 40 where the rotating rotor 48 forces it out through the stator 46. For delivery of the drywall material to a remote location, a hose 21 is connected to the end of the stator 46 that extends away from the pump housing 40. To facilitate that connection, the stator 46 is threaded to receive a standard pipefitting. The most common type of pipefitting for this purpose is a reducer 89. In this way the hose 21 can be attached via a readily obtainable common pipefitting.

As illustrated in FIG. 6, the remote end of the hose 21 is shown connected to a spray gun 92. The spray gun 92 is of conventional design and is standard equipment for spray systems wherein a compressor (not illustrated) supplies compressed air to the spray gun 92 through an air hose 93.

When the pump 38 is in operation, the thrust forces generated by the rotating rotor 48 pushing material out the stator 46 tend to urge the rotor 48 back toward the gear reducer 30. While this method of coupling the connecting rod 68 to the square drive coupler 62 and the rotor 48 prevents the rod 68 from disconnecting and allows easy disassembly for repair or replacement of parts, it does cause substantial wear on the connection rod 68 and the components to which it is attached, eventually requiring replacement.

In addition, in some applications the rotor 48 rotates inside a rubberized stator in an elliptical fashion that is non-symmetrical and variable. This creates relative movement between the rotor 48 and the drive shaft 36. The above-described coupling mechanism does not accommodate this relative movement, which causes increased wear and early failure of the coupling assembly parts.

### BRIEF SUMMARY OF THE INVENTION

The present disclosure is directed, in one embodiment, to a coupling for transmitting a drive force from a prime mover to a driven member and, in one application in particular, for transmitting force from a motor to a pump rotor, such as used on spray equipment.

In one embodiment, a connecting rod for coupling to a mating socket or to a coupler is provided. The connecting rod includes a shaft having a longitudinal axis, a first end, and a second end, at least one of the first and second ends of the shaft having a substantially convex end face that is preferably arcuate or hemispherical in shape; and a spline formed on at least one of the first and second ends of the shaft, the spline having at least two projections that extend from the shaft to be substantially parallel to the longitudinal axis of the shaft, the projections contoured to accommodate universal movement of the shaft relative to the socket.

In accordance with another aspect of the disclosure, the spline projections are contoured to taper into the convex or hemispherical end face of the shaft.

In accordance with another aspect of the disclosure, the spline projections can extend the entire length of the shaft, or in the alternative it can be formed at each of the first and second ends or span the entire length of the shaft.

In accordance with another aspect of the disclosure, the universal movement of the shaft when engaged in the mating socket is in the range of 2 degrees to 4 degrees relative to a longitudinal axis of the mating socket.

In accordance with another aspect of the disclosure, a coupling assembly is provided that includes a connecting rod comprising a shaft having a longitudinal axis, a first end and a second end, the first and second ends each having an end profile bound by a substantially hemispherical surface, the shaft including a spline formed on at least the first and second ends, the spline comprising at least two projections that extend from the shaft and are substantially parallel to the longitudinal axis of the shaft; and a coupler having a mating socket with substantially the inverse profile of the shaft end-spline combination that is adapted to allow for universal movement of the connecting rod relative to the mating socket.

In accordance with another embodiment of the disclosure, a coupling assembly is provided that includes a connecting rod having means located on a first end and a second end for drivingly connecting rotating components; and a coupler having means for receiving and engaging the connecting rod and adapted to allow for universal movement of the connecting rod relative to the coupler housing.

In accordance with another embodiment of the disclosure, a spray system is provided that includes a drive assembly having an electrically activated motor; a driven assembly that includes a pump, the pump having a pump housing, a stator and a rotor disposed within the stator for rotation about a rotational axis; and a coupling assembly that includes a connecting rod, a first coupler member and a second coupler member, wherein the connecting rod is adapted to transmit rotary motion from the first coupler member, which is coupled to a driver such as a motor, to the second coupler member, which is coupled to the rotor, and to allow for or enable universal movement of the connecting rod relative to either or both of the first and second coupler members.

In accordance with another embodiment of the disclosure, a spray system is provided that includes a frame; an electrically or hydraulically activated motor supported by the frame, the motor having a motor drive shaft; a gear reducer having a driven end and a drive end, the driven end configured to receive and engage the motor drive shaft, the drive end having a gear reducer drive shaft that rotates about a gear reducer drive shaft axis in response to electrical activation of the motor; a pump that includes a pump housing, the pump housing directly coupled to the drive end of the gear reducer, the pump housing defining a containment chamber to contain liquid material therein and an inlet port for receiving and directing liquid material into the containment chamber; a stator mounted to the pump housing; a rotor disposed within the stator for rotation about a rotor axis; and a connecting rod having an elongate shaft with a longitudinal axis, a first end and a second end, at least one of the first and second ends each having an end profile bounded by a substantially hemispherical end face, and a spline formed on at least the first and second ends, the spline having at least two projections that project from a sidewall of the shaft, that are substantially parallel with the longitudinal axis of the shaft, and that are contoured to fit in matching sockets to allow for universal movement of the shaft relative to either one or both of the gear reducer drive shaft axis and to the rotor axis.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is an isometric projection of applicant's prior patented portable spray system;

FIG. 2 is an exploded view of the portable spray system of FIG. 1;

FIG. 3 is a side view in partial cut away of a pump housing with stator having a rotor seated therein;

FIG. 4 is an enlarged cross-sectional side view illustrating a connection between a gear reducer and a pump housing of the spray system of FIG. 1;

FIG. 5 is an exploded isometric view of the spray pump components of the spray system of FIG. 1;

FIG. 6 is an exploded side view of a spray gun for use with the spray system of FIG. 1;

FIG. 7 is an isometric projection of a connecting rod formed in accordance with the present disclosure;

FIG. 8 is a side elevational view of the connecting rod of FIG. 7;

FIG. 9 is a cross-sectional view taken along lines 9-9 of the connecting rod of FIG. 8;

FIG. 10 is a front elevational view of a coupler socket formed in accordance with the present disclosure;

FIG. 11 is a side elevational view of the coupler socket of FIG. 10;

FIG. 12 is an isometric projection of the connecting rod of FIG. 7 coupled to the coupler socket of FIG. 10; and

FIG. 13 is an exploded view of a pump assembly formed in accordance with the present disclosure.

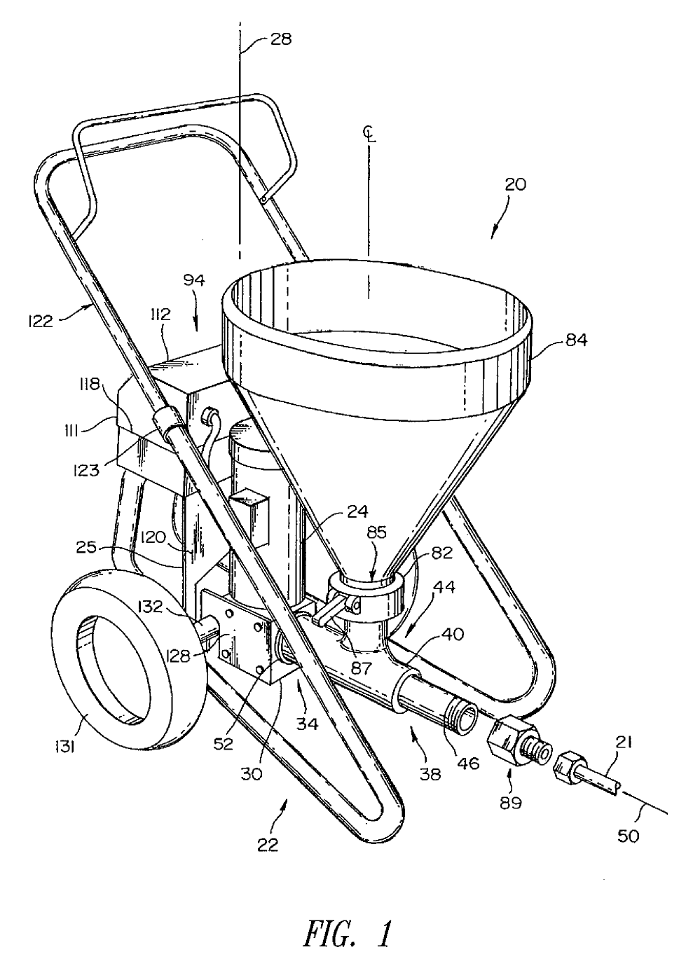

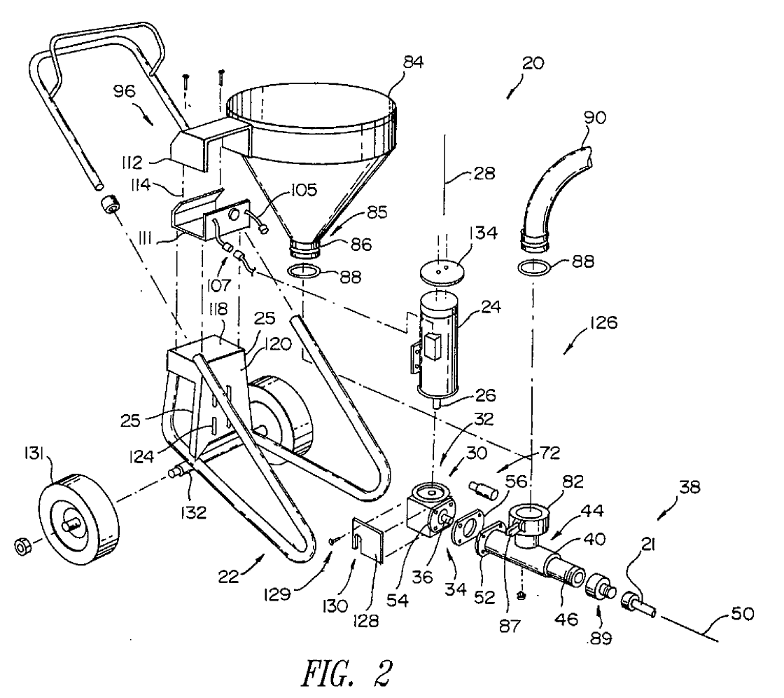

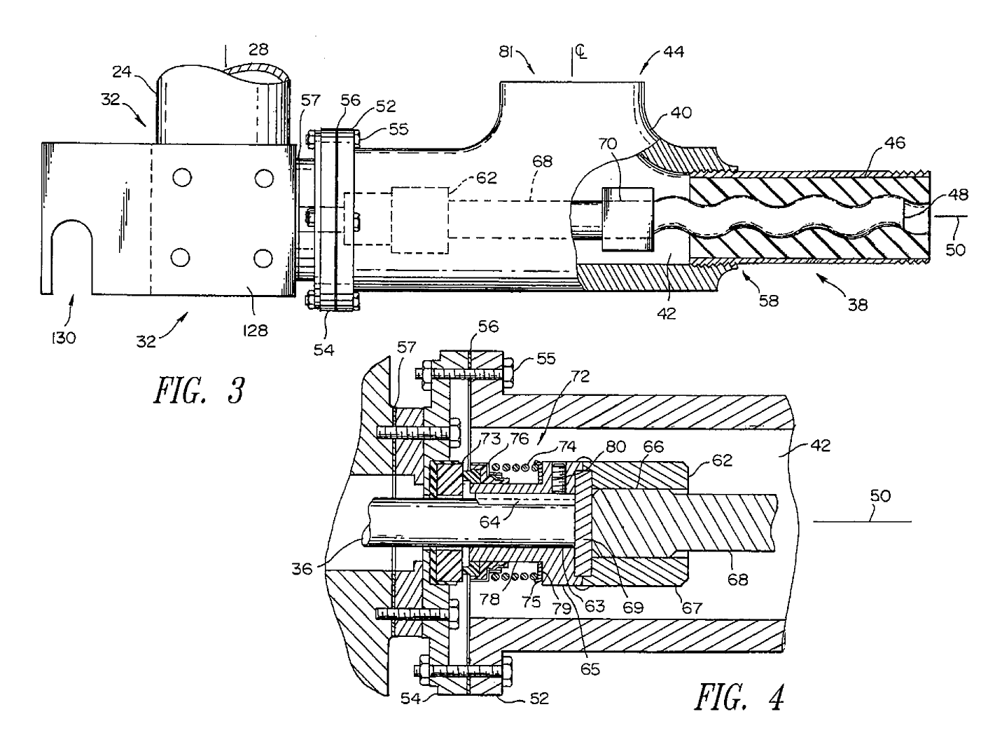

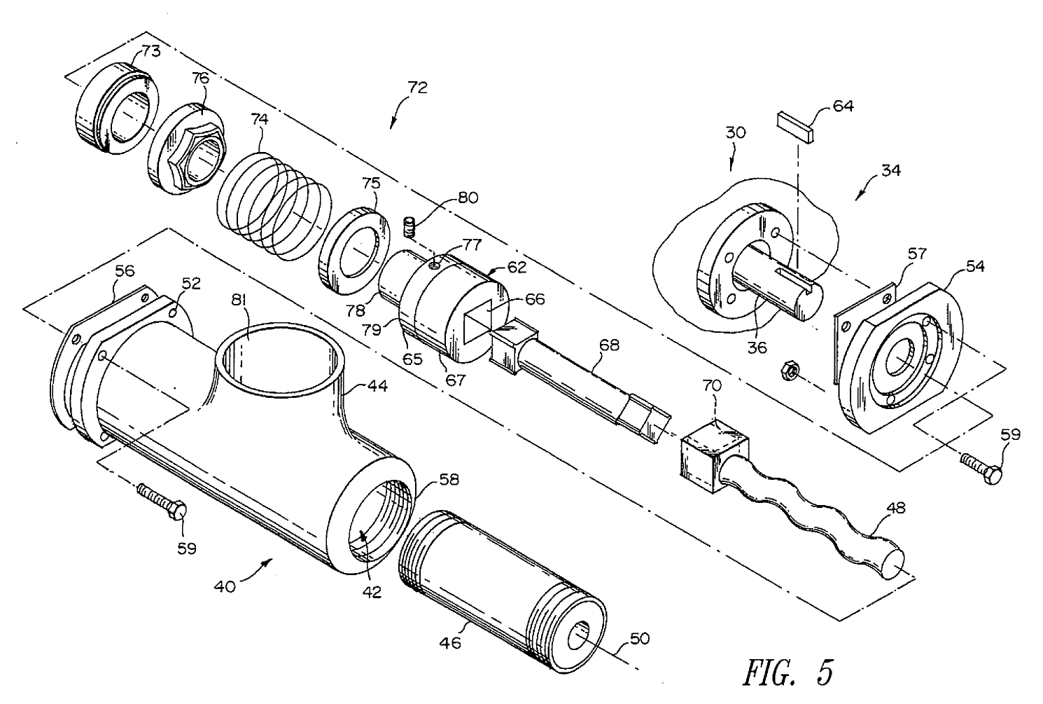

### DETAILED DESCRIPTION OF THE INVENTION

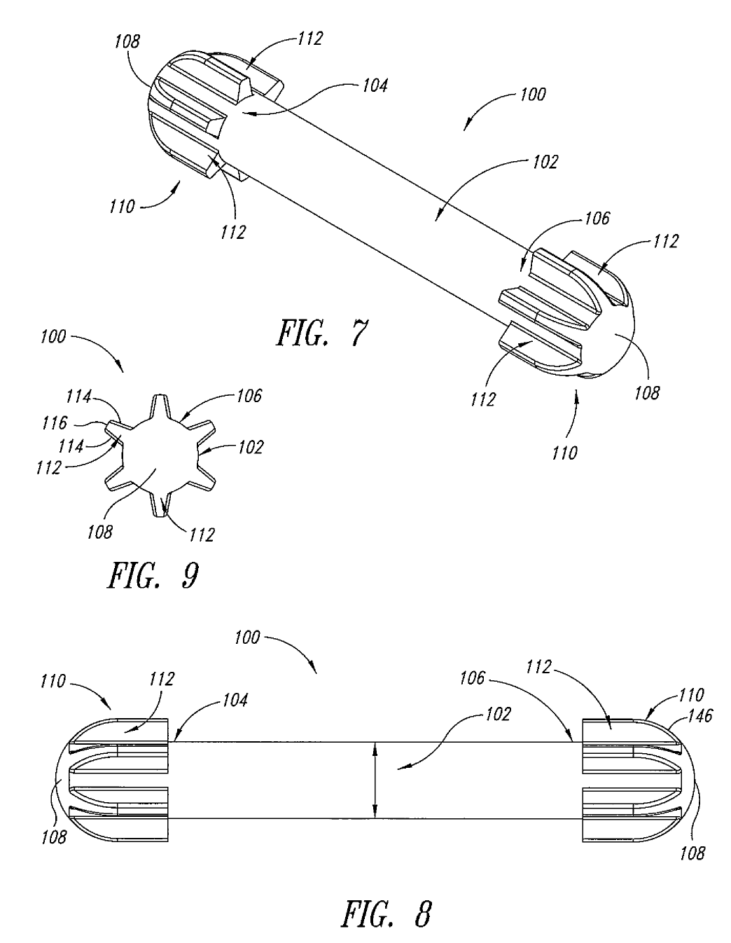

The embodiments of the present disclosure are directed to a spray pump system and accompanying coupling apparatus as illustrated in FIGS. 7-13. Referring initially to FIGS. 7-8, a connecting rod 100 is illustrated in the form of an elongate shaft 102 having first and second ends 104, 106. Each of the first and second ends 104, 106 has an end face 108 that is convex and arcuate.

Ideally, the shaft 102 of the connecting rod 100 is formed from solid material, preferably metal. The end faces 108 are formed to have a smooth curved surface. In accordance with one embodiment, the shaft 102 has a length in the range of 4 inches to 12 inches, a diameter in the range of ¾ inch to 2 inches, and the radius of curvature of at least one or both of the end faces 108 is in the range of ½ inch to 2 inches. Because the connecting rod 100 can be sized and shaped to accommodate various applications, such as manually portable spray machines up to large industrial-sized spray rigs, the present disclosure can be adapted to meet these applications.

As shown in FIGS. 7-8, ideally, adjacent each end 104, 106 of the shaft 102 is a spline 110 formed thereon that, in this embodiment, takes the shape of a plurality of elongate projections 112 extending substantially orthogonal from the sidewall 118 of the shaft 102. It is to be understood that the spline 110 can be formed at only one end if desirable for a particular application. Each projection 112 is in the form of a wall extending from a surface of the shaft and having substantially planar sides 114 that in the illustrated embodiment converge toward a top surface 116, which also is substantially planar. While the top surface 116 can be rounded, having the top surface 116 planar is preferred in order to provide more contact area.

As shown in the illustrated embodiment, the projections 112 at each of the first and second ends 104, 106 are contoured to taper into the end face 108. Ideally, the contour is in the form of a curved profile having an arc with a radius that either matches the radius of the end face 108 or is substantially close to the radius of the end face 108.

Although the spline 110 shown on each end 104, 106 of the shaft 102 terminates part way down the shaft 102, it is to be understood that in another embodiment the connecting rod 100 can be formed so that the spline extends from the first end 104 to the second end 106. In addition, while six projections 112 are shown in this particular configuration of the spline 110, it is to be understood that the spline 110 can consist of five projections, four projections, three projections, two projections, or more than six projections. Ideally six projections are used because this provides the best balance between strength and manufacturing costs and complexity. In addition, the height of each projection 112 above the sidewall of the shaft 102 will vary according to the needs of a particular application, but generally will be in the range of ⅛ inch to ¼ inch.

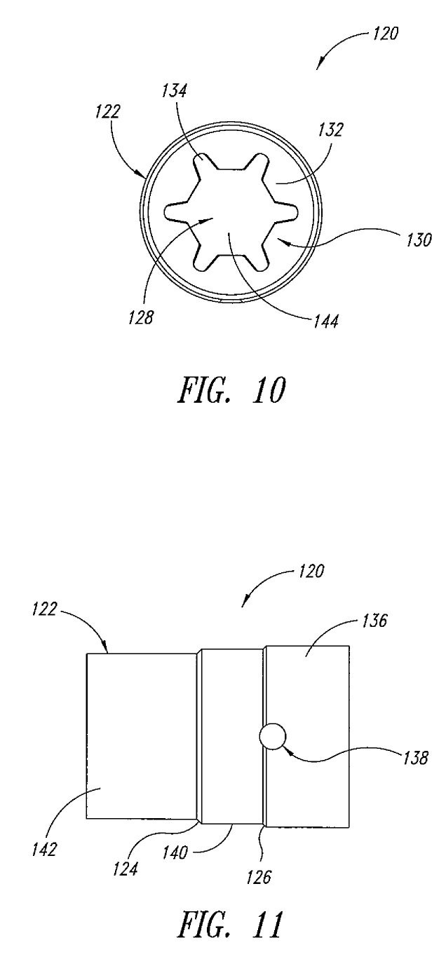

Turning to FIGS. 10 and 11, shown therein is a double-ended socket or coupler 120 having an overall cylindrical or tubular shape defined by an annular body 122. As shown in FIG. 11, in one embodiment the annular body 122 has an increasing external and internal diameter that is stepped to form external shoulders 124, 126 that accommodate an increasing internal diameter and that divide the coupler in to a large diameter first section 136, a second intermediate diameter section 140, and a small diameter third section 142. The coupler 120 includes a longitudinal axial bore 128 forming a socket in the third section 142 having an internal spline 130 therein. More particularly, the internal spline 130 is formed to have a series of projections 132 and slots 134 that are substantially a mirror image of the spline 110 on the first and second ends 104, 106 of the connecting rod 100. Thus the internal spline 130 is sized and shaped to accommodate in slidable engagement the external spline 110 on the connecting rod 100.

In this particular embodiment, the large diameter first section 136 of the coupler 120 has an axial bore (not shown) that is sized and shaped to receive a shaft, such as a shaft from a motor. A threaded opening 138 is formed in the annular body that communicates with the axial bore to receive a set screw (not shown) that holds the coupler 120 in engagement with the shaft. The second section 140 defined between the first and second shoulders 124, 126, transitions between the large internal diameter first section 136 and the small internal diameter third section 142 and supports an interior wall 144 that separates the axial bore 128 into two sections corresponding to the smaller internal and external diameter third section 142 and the larger internal and external diameter first section 136.

The interior wall 144 has a concave surface facing the internal spline 130 that matches the radius of curvature of the end face 108 on the connecting rod 100. This is to provide maximum contact area between the connecting rod 100 and the coupler 120. In addition, the tapered section 146 of the projections 112 on the connecting rod 100 have a matching surface in the slots 134 on the interior of the coupler 120 as they transition and taper in to the smooth concave wall 144.

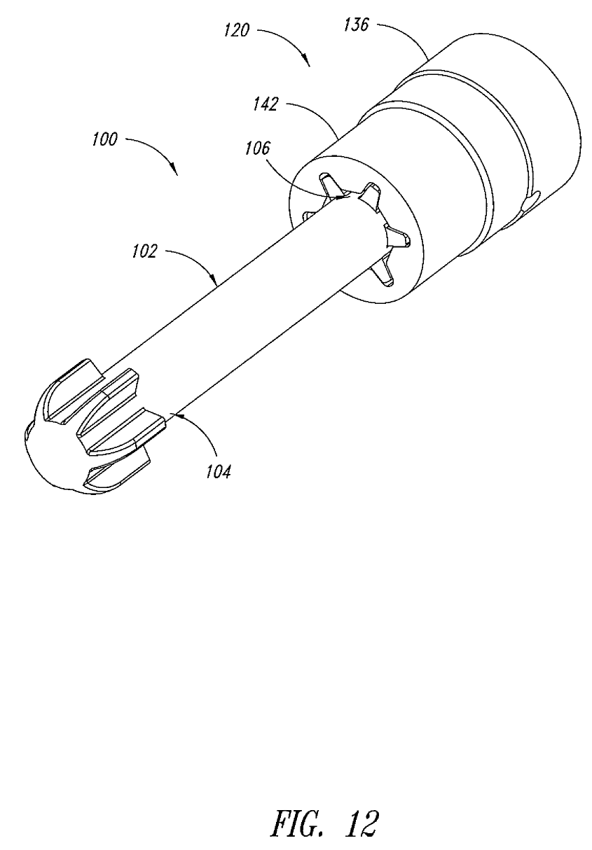

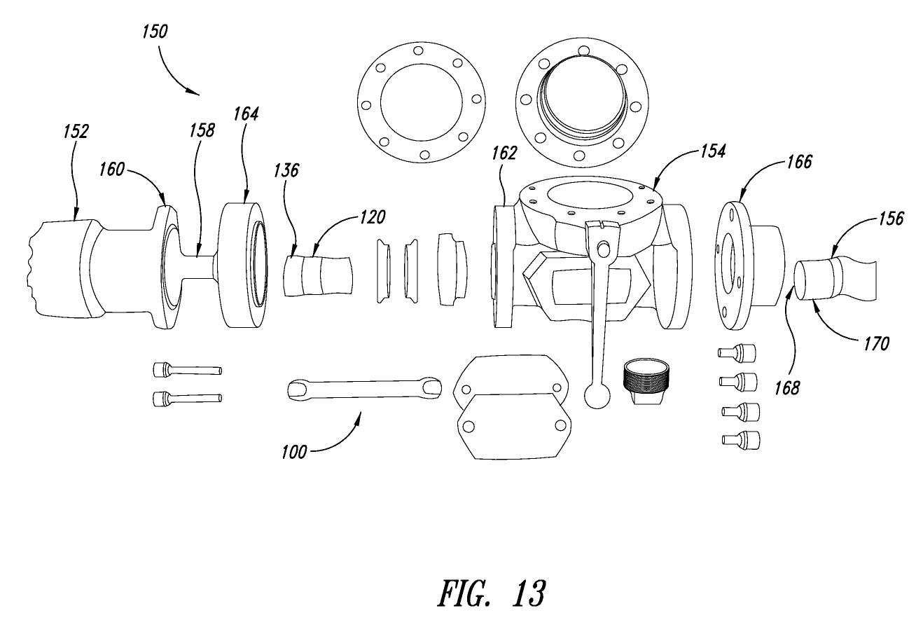

When the connecting rod 100 is slidably received in the mating coupler 120, as shown in FIG. 12, the end face 108 of the connecting rod 100 will bear against the matching wall 144 on the interior of the coupler 120. In addition, as shown in FIG. 12, the projections 112 on the spline 110 will be formed to extend out of the coupler 120 a predetermined distance, ideally in the range of 1/20 to ⅕ of an inch and preferably 1/10 of an inch. This prevents the projections 112 from creating an internal lip near the edge of the axial bore 128, which could cause the connecting rod 100 to bind in the coupler 120, interfering with the operation of the system and making it difficult to disassemble and service.

The relationship between the connecting rod 100 and the coupler 120 is such that the connecting rod 100 will have universal movement with respect to the coupler 120. In other words, the connecting rod 100 will be able to change its angular relationship with respect to the longitudinal axis of the coupler 120 during rotation without compromising strength or the transfer of force, as described in more detail below. Thus, the coupling or joint between the connecting rod 100 and the coupler 120 can be considered a universal joint. In one embodiment, the amount of universal movement as measured by the angular displacement between a longitudinal axis of the connecting rod 100 and a longitudinal axis of the coupler 120 is in the range of 0 degrees to 4 degrees, although 2 degrees is preferred.

Shown in FIG. 13 is an application of a coupler assembly formed in accordance with the present disclosure, which as shown herein includes the connecting rod 100 and the coupler 120, as well as the matching internal spline on the rotor 48. FIG. 13 is an exploded view of a pump assembly 150 that includes a motor 152 adapted for coupling to a pump housing 154 that has a stator (not shown) configured to receive a rotor 156. It is to be understood that the motor 152 can be electric, hydraulic, pneumatic, or belt driven.

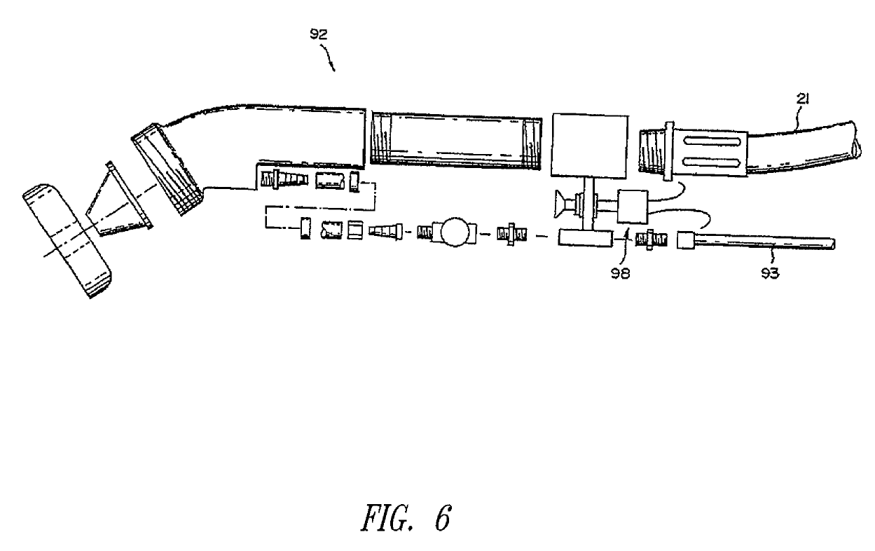

The motor 152 has a shaft 158 that is sized and shaped to be slidably received into the large diameter first end 136 of the coupler 120 and held in place by a set screw (not shown) threadably received in the opening 138. The motor 152 includes a mounting flange 160 that is bolted to a corresponding mounting flange 162 on the pump housing 154 through an adaptor plate 164. A stator tube flange 166 is shown to the right of the pump housing 154, and a hose and nozzle, such as shown in FIG. 6, are coupled to the stator tube flange 166 either directly or through other coupling elements.

The connecting rod 100 is received in the coupler 120 and within a corresponding internal spline 168 formed on an interior of a receiving end 170 of the rotor 156. The internal spline 168 is configured nearly identical to the internal spline 130 on the coupler 120 to enable universal movement of the connecting rod 100 with respect to the rotor 156. Gaskets and other mounting hardware are shown but not described in detail in FIG. 13, such as a seal assembly that includes a seal retainer 172 adapted to receive a first seal 174 and a second seal 176 adapted to seat in the adaptor plate 164.

In use, the motor 152 rotates the shaft 158, which in turn rotates the coupler 120. The drive force from the motor is transferred from the coupler to the connecting rod 100 and thence to the rotor 156, which rotates within a rubberized stator (not shown) in the pump housing 154. In one form, the pump is a progressive cavity pump wherein liquid in the pump housing 154 is gravity fed from a reservoir (not shown) and drawn in to the pump housing 154 by the rotation of the rotor 156, and in turn the liquid is forced out of the pump housing 154 through the stator tube flange 166 in a manner as described above with respect to applicant's prior spray system.

From the foregoing it will be appreciated that, although specific embodiments of the invention have been described herein for purposes of illustration, various modifications may be made without deviating from the scope of the invention. Accordingly, the invention is not limited except as by the appended claims and the equivalent's thereof.

We claim:

1. A connecting rod for coupling to a mating socket, the connecting rod comprising:
a shaft having a longitudinal axis, a first end, and a second end, the first and second ends of the shaft each having a substantially convex end face; and
a spline formed at least adjacent to the first and second ends of the shaft, the spline comprising at least two projections that project from the shaft and are substantially parallel to the longitudinal axis of the shaft, the projections contoured to accommodate universal movement of the shaft relative to the socket.

2. The connecting rod of claim 1 wherein the spline projections are contoured to taper into the substantially convex end face of the shaft.

3. The connecting rod of claim 1 wherein the spline extends the full length of the shaft.

4. The connecting rod of claim 1 wherein the universal movement of the shaft when engaged in the socket is in the range of 0 to 4 degrees relative to a longitudinal axis of the socket.

5. A coupling assembly, comprising:
a connecting rod comprising a shaft having a longitudinal axis, a first end and a second end, the first and second ends each having an end profile bound by a substantially hemispherical surface, the shaft including a spline formed at least adjacent the first and second ends, the spline comprising at least two projections that extend from the shaft and are substantially parallel to the longitudinal axis of the shaft; and
a coupler having a mating socket with substantially the inverse profile of at least one of the first and second ends of the shaft and spline combination that is adapted to allow for universal movement of the connecting rod relative to the mating socket when the connecting rod has the at least one of the first and second ends engaged in the mating socket.

6. The connecting rod of claim 1 wherein the spline projections are contoured to taper into the substantially hemispherical end face of the shaft.

7. The connecting rod of claim 1 wherein the spline extends the full length of the shaft.

8. The connecting rod of claim 1 wherein the universal movement of the shaft when engaged in the socket is in the range of 0 to 4 degrees relative to a longitudinal axis of the socket.

9. A coupling assembly, comprising:
a connecting rod having means located on at least a first end or a second end for drivingly connecting rotating components; and
a coupler housing having means for receiving and engaging the at least first or second end of the connecting rod, the connecting rod and the coupler adapted to allow for universal movement of the connecting rod relative to the coupler housing.

10. The assembly of claim 9 wherein the means on at least the first or second end of the connecting rod comprises a hemispherical end face on the connecting rod and a spline formed adjacent the hemispherical end face.

11. The assembly of claim 10 wherein the means for receiving on the coupler housing comprises a socket having an interior sized and shaped to accommodate the at least first end or second end of the connecting rod.

12. A spray system, comprising:
a drive assembly comprising a motor;
a driven assembly comprising a pump, the pump comprising a pump housing, a stator and a rotor disposed within the stator for rotation about a rotational axis; and
a coupling assembly comprising a connecting rod, a first coupler member and a second coupler member, wherein the connecting rod is sized and shaped to transmit rotary motion from the first coupler member that is coupled to the drive assembly to the second coupler member that is coupled to the rotor and to allow for universal movement of the connecting rod relative to each of the first and second coupler members.

13. The system of claim 12 wherein the connecting rod comprises:
a shaft having a longitudinal axis, a first end, and a second end, the first and second ends of the shaft each having a substantially convex end face; and
a spline formed at least adjacent to the first and second ends of the shaft, the spline comprising at least two projections that project from the shaft and are substantially parallel to the longitudinal axis of the shaft, the projections contoured to accommodate universal movement of the shaft relative to the socket.

14. The connecting rod of claim 13 wherein the spline projections are contoured to taper into the substantially convex end face of the shaft.

15. The connecting rod of claim 13 wherein the spline extends the full length of the shaft.

16. The connecting rod of claim 13 wherein the universal movement of the shaft when engaged in the socket is in the range of 0 to 4 degrees relative to a longitudinal axis of the socket.

17. A spray system, comprising:
a frame;
a motor supported by the frame, the motor having a motor drive shaft that rotates about a motor drive shaft axis;
a gear reducer having a driven end and a drive end, the driven end configured to receive and engage the motor drive shaft, the drive end having a gear reducer drive shaft that rotates about a gear reducer drive shaft axis in response to electrical activation of the motor;
a pump comprising a pump housing, the pump housing being directly coupled to the drive end of the gear reducer, the pump housing defining a containment chamber to contain liquid material therein and an inlet port for receiving and directing liquid material into the containment chamber;
a stator mounted to the pump housing;
a rotor disposed within the stator for rotation about a rotor axis; and
a connecting rod comprising a shaft having a longitudinal axis, a first end and a second end, the first and second ends each having an end profile bounded by a substantially convex end face, and a spline formed on at least the first and second ends, the spline comprising at least two projections that project from a sidewall of the shaft, that are substantially parallel with the longitudinal axis of the shaft, and that are contoured to allow universal movement of the shaft relative to the gear reducer drive shaft axis and to the rotor axis when received in matching sockets in the gear reducer drive shaft and the rotor.

18. The system of claim 17 wherein the spline extends an entire length of the shaft.
